(19) United States
(12) Patent Application Publication
(10) Pub. No.: US 2010/0145375 A1
(43) Pub. Date: Jun. 10, 2010

(54) Apparatus Useful for Rodent Tail Lateral Vessel Transection

(75) Inventor: Pengxuan Liu, El Sobrante, CA (US)

Correspondence Address: BAYER HEALTHCARE LLC, Law & Patents, 800 Dwight Way, BERKELEY, CA, 94710, US

(73) Assignee: BAYER HEALTHCARE LLC, Tarrytown, NY (US)

(21) Appl. No.: 12/550,163

(22) Filed: Aug. 28, 2009

Related U.S. Application Data
(60) Provisional application No. 61/092,524, filed on Aug. 28, 2008.

(51) Int. Cl. A61D 1/00

(52) U.S. Cl. 606/172; 606/167

(57) ABSTRACT

Provided herein is an apparatus useful for transection of one lateral vessel in the bleeding model of hemophilic specimen, which is to mimic the venous bleeding in hemophiliac patients, for evaluating the efficacy of potential procoagulant therapeutics.

### REFERENCE TO RELATED APPLICATIONS

The present application claims benefit of priority to U.S. Provisional Application No. 61/092,524, filed Aug. 28, 2008 which is hereby incorporated by reference for all purposes.

### FIELD OF THE INVENTION

The present invention relates to an apparatus suitable for use when performing rodent tail lateral vessel transections. More specifically, the present invention relates to an apparatus useful for controlling and managing the depth of the incision in the tail.

### BACKGROUND OF THE INVENTION

Tail bleeding time is widely used in mice and rats, particularly when evaluating pharmacologic and/or genetic interventions that impair haemostatic function of many coagulation factors. A widely used method is a complete transection of the tail 1 to 5 mm from the tip. Alternate techniques include a longitudinal incision on the dorsal part of the tail a set distance from the tip, a single puncture of the dorsal tail vein with a needle, or a transverse incision over a lateral tail vessel, i.e. vein or artery.

Where a transverse incision over one of the lateral tail vessels is used, the depth and the position of the incision are critical as it directly affects the bleeding outcome. With regard to position, the tail should be cut at a position where the diameter of the tail is between about 2.2 mm and 2.9 mm. Typically, the position is where the diameter of the tail is about 2.7 mm and the depth of the incision is deep enough to sever the vein completely but not deep enough to cut other important vessels or bone in the tail. Generally, given a tail about 2.7 mm in diameter, the incision should be around 0.9 mm deep in order to cut through the lateral vein entirely or roughly one third the diameter.

Such incisions are generally made by hand and rely on the skill of the handler. However, because of variations in hand pressure (e.g. as a result of fatigue), blade sharpness, or skin/muscle thickness, it is difficult to generate consistent results. The incision may fail to completely sever the lateral vein. The incision may completely sever the tail. The incision may cut through the bone, leaving only the skin on the opposite side holding the tail together. Further, if multiple handlers are performing transections, this creates additional variation. This of course may be alleviated by having one handler perform all the transections, but this is not an optimal solution and does not account for the aforementioned individual variations.

### DESCRIPTION OF THE DRAWINGS

FIG. 1 shows A) a schematic of the tail lateral vessel transaction (TLVT) apparatus from the front and B) a close up of one of the holes in the vertical element.

FIG. 2 depicts a schematic of the TLVT apparatus from above.

FIG. 3 depicts A) a schematic of the TLVT apparatus from the side and B) a close up of the vertical elements showing the position of the hole and the distance between the vertical elements.

FIG. 4 depicts a 3-D profile view of the TLVT apparatus.

### SUMMARY OF THE INVENTION

The present invention relates to a guide or template for managing depth of the incision during a tail lateral vessel transection, particularly for a lateral vein. Provided herein is an apparatus useful for transection of one lateral vessel in the bleeding model of hemophilic specimens (e.g. mice or rats), which is to mimic the venous bleeding in hemophiliac patients, for evaluating the efficacy of potential procoagulant therapeutics.

Provided is an apparatus useful for tail lateral vessel transections of a specimen comprising: a base; a first vertical element, wherein the first vertical element comprises a first plurality of holes placed at predetermined positions; and a second vertical element, wherein the second vertical element is positioned parallel and adjacent to the first vertical element such that a gap is formed between the first and second vertical elements and wherein the second vertical element comprises a second plurality of holes aligned with the first plurality of holes on the first vertical element.

The present invention further provides for a method of performing tail lateral vessel transections. Using the apparatus, a specimen is provided and the specimen's tail is placed through one aligned pair of holes of the first and second vertical elements. A blade is placed in the gap with the handle of the blade resting on the vertical elements. The blade is then run along the length of the vertical elements, thereby making an incision in the specimen's tail.

### DETAILED DESCRIPTION OF THE INVENTION

It is to be understood that this invention is not limited to the particular methodology, protocols, cell lines, animal species or genera, constructs, and reagents described and as such may vary. It is also to be understood that the terminology used herein is for the purpose of describing particular embodiments only, and is not intended to limit the scope of the present invention which will be limited only by the appended claims.

It must be noted that as used herein and in the appended claims, the singular forms “a,” “and,” and “the” include plural reference unless the context clearly dictates otherwise. Thus, for example, reference to “a tail” is a reference to one or more tails and includes equivalents thereof known to those skilled in the art, and so forth.

Unless defined otherwise, all technical and scientific terms used herein have the same meaning as commonly understood to one of ordinary skill in the art to which this invention belongs. Although any methods, devices, and materials similar or equivalent to those described herein can be used in the practice or testing of the invention, the preferred methods, devices and materials are now described.

All publications and patents mentioned herein are hereby incorporated herein by reference for the purpose of describing and disclosing, for example, the constructs and methodologies that are described in the publications which might be used in connection with the presently described invention. The publications discussed above and throughout the text are provided solely for their disclosure prior to the filing date of the present application. Nothing herein is to be construed as an admission that the inventors are not entitled to antedate such disclosure by virtue of prior invention.

### Tail Lateral Vessel Transection Apparatus

The present invention provides for a guide or template useful for standardizing tail lateral vessel transections (TLVT). Specifically, the guide allows for a more consistent result when performing a TLVT by managing the depth of the incision and by standardizing the diameter of the tail where the incision is made.

The present invention provides for an apparatus useful for tail lateral vessel transections of a specimen comprising: a base; a first vertical element, wherein the first vertical element comprises a first plurality of holes placed at predetermined positions; and a second vertical element, wherein the second vertical element is positioned parallel and adjacent to the first vertical element such that a gap is formed between the first and second vertical elements and wherein the second vertical element comprises a second plurality of holes aligned with the first plurality of holes on the first vertical element.

Briefly, the TLVT apparatus is used by placing the tail of the specimen through a pair of aligned holes of the first and second element, and running a blade in the gap between the first and second vertical elements to incise the tail. The holes provide a means to ensure that the diameter of the tail is proper, while the vertical elements provide a means to limit the depth of the blade in relation to the holes and tail.

In some embodiments, the specimen is a mammal, in particular a rodent which can include but is not limited to a rat or a mouse. In other embodiments, the specimen is any suitable organism on which a tail vein transection is done to study and test bleeding time. In some embodiments, the specimen has a hemophilic disorder.

In some embodiments, the base, the first vertical element and second vertical element are comprised of a material such as a plastic, polymer, metal, glass, wood, stone, ceramic, carbon fiber or combination thereof. In some embodiments, the first and second vertical elements are the same height from the base. The height of the vertical elements is important as it determines how far the blade will penetrate the tail.

In some embodiments, the first and second vertical elements are of the same thickness. In some embodiments, the thickness is 1-10 mm. In some embodiments, the thickness is 3 mm and in other embodiments, 6 mm.

The gap between the first and second elements provides a guide through which a blade is passed. Thus, the gap should be at least as wide as the width of a blade. Such blades that can be used are scalpels, knives, razor blades, or any other sharp object suitable for cutting. In some embodiments, the gap between the first and second vertical elements is about 0.3 mm to 1.5 mm.

In one aspect of the invention, the diameter of the plurality of holes on the vertical elements provides for a guideline of where the incision should be made on the tail. In some embodiments, the first plurality of holes has a diameter of about 2.2 mm to 2.9 mm. In some embodiments, the first plurality of holes has a diameter of 2.7 mm.

In some embodiments, the second plurality of holes has a diameter of about 2.2 mm to 2.9 mm. In some embodiments, the second plurality of holes have a diameter of 2.7 mm on an inner face of the second vertical element and a diameter of 8 mm on an outer face of the second vertical element. The inner face refers to the side of the second vertical element closest to the first vertical element. The inner face creates one wall of the gap. The outer face refers to the opposite side.

In some embodiments, the first plurality of holes and the second plurality of holes have an increasing height from the base to account for different types of blade used. Because the blade rests atop of the vertical elements, some blades will reach further into the gap than others either based upon design or based upon manufacturing variations. Thus, holes at various heights will allow the specimen's tail to be inserted to provide the proper depth of cut. The proper depth of cut can be determine by placing the blade into the gap and viewing through each aligned pair of holes to determine how much of the blade is visible. The amount of blade visible corresponds to the depth of the cut.

In some embodiments, the first and second pluralities of holes are at the same height. By having holes at the same height, it is possible to perform the TLVT on more than one sample at a time. Thus, it is possible to perform the TLVT on all samples at once to get direct comparisons.

In another aspect of the invention, the tail lateral vessel transection apparatus further comprises a sliding blade. In some embodiments, this sliding blade may be mounted to at least one of the vertical members to move laterally along the top of the vertical member with a blade protruding into the gap. In some embodiments, the sliding blade may have a replaceable blade. In other embodiments, the sliding blade may include a means for minor adjustments of height of the blade for optimal depth of cut.

Accordingly, the TLVT apparatus is easy to use, reduces the operation time and maintains a standardized depth when working with one or more mice. Further, the present invention removes variation by standardizing the depth and position of incisions made by two handlers.

### Method of Performing Tail Vein Transection Apparatus

The present invention further provides for a method of performing tail vein transections using the apparatus. The method comprises the steps of: a) providing a specimen, b) placing the specimen's tail through one aligned pair of holes of the first and second vertical elements, c) placing a blade in the gap with the handle of the blade resting on the vertical elements, d) running the blade laterally along the vertical element to make an incision on the tail.

### EXAMPLES

It will be apparent to those skilled in the art that the examples and embodiments described herein are by way of illustration and not of limitation, and that other examples may be used without departing from the spirit and scope of the present invention, as set forth in the claims.

### Example 1

### Schematic of TLVT Apparatus

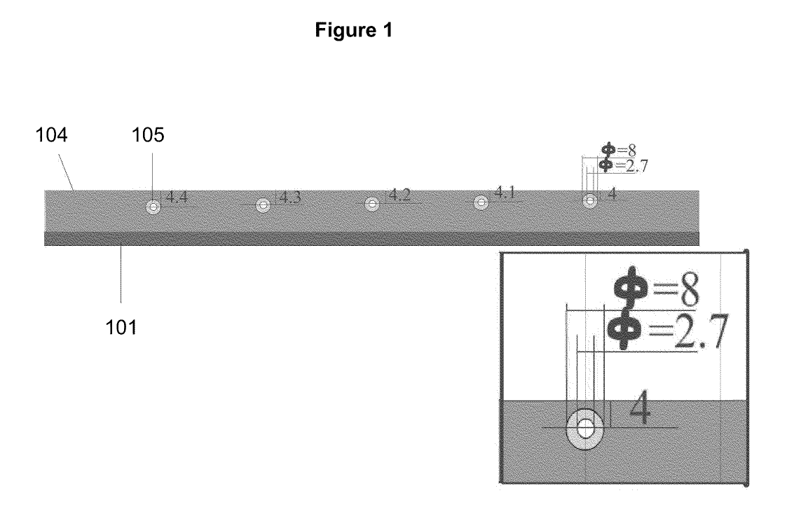

Shown in FIGS. 1 through 4 is a schematic of some embodiments of the present invention. FIG. 4 is an overall three-dimensional profile view of one model for the TLVT apparatus. FIG. 1(A) shows a schematic of the front of the model. In this model, the second vertical element (104) with 5 holes (105) and base (101) are shown. Each hole is placed at a predetermined position and each hole is from right to left is progressively closer to the top of the vertical element. The center of the first hole is 4.4 mm from the top. Each successive hole is closer to the top by a 0.1 mm increment. FIG. 1(B) is a close up of the last hole. The hole has an inner wall diameter (φ) of 2.7 mm and an outer wall diameter of 8 mm. The center of the hole is 4 mm from the top of the vertical element.

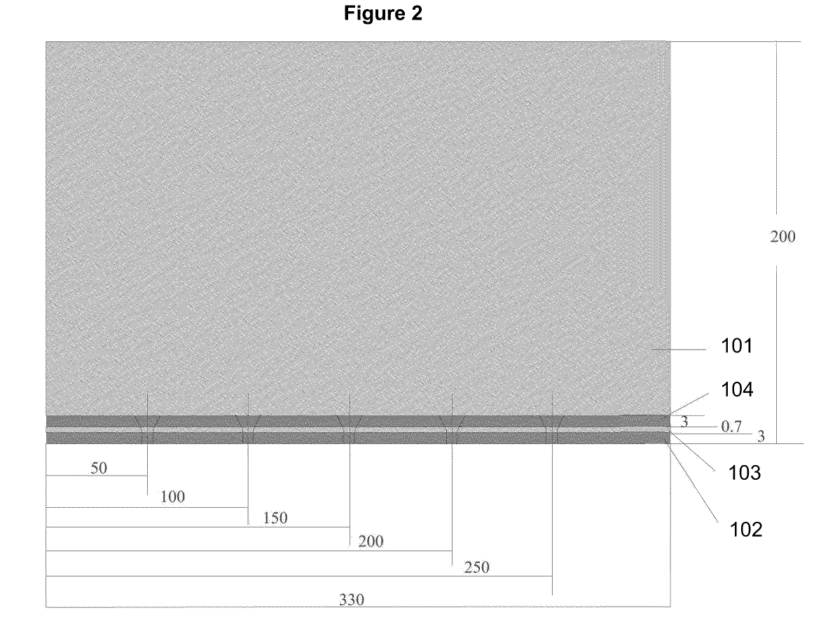

Referring now to FIG. 2, shown is the top view of the same model. In this model, the base (101) is 200 mm by 300 mm. Each aligned set of holes is set 50 mm apart. FIG. 2 also shows the position of the first vertical element (102) in relation to the second vertical element (104) and the gap (103). Here, each vertical element has a thickness of 3 mm, but may be thinner or thicker. Here, the gap is 0.7 mm wide.

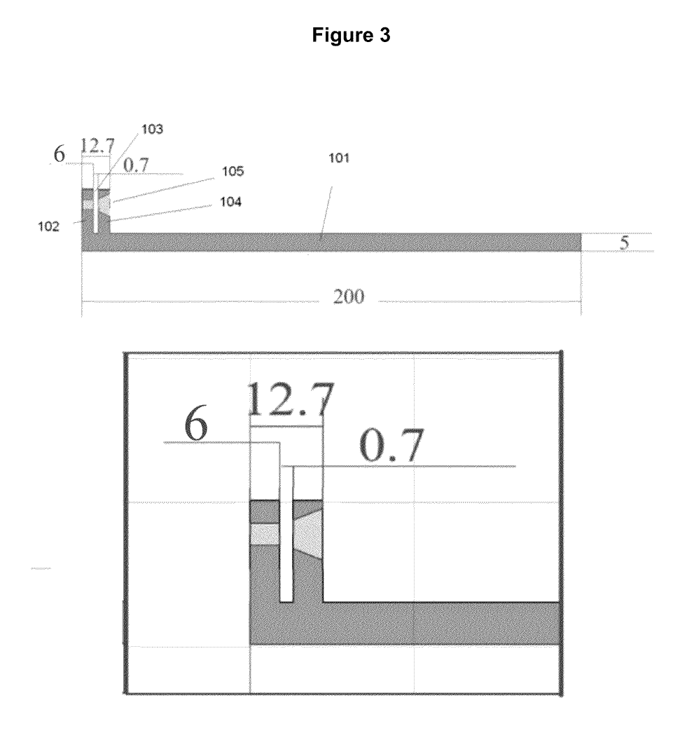

FIG. 3(A) shows the side view of the same model. This shows the thickness of the base is 5 mm. FIG. 3(B) is a close up of the vertical elements. From this figure, it clearly depicts the diameter difference between the inner and outer wall of the second vertical element.

All publications and patents mentioned in the above specification are incorporated herein by reference. Various modifications and variations of the described methods of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the above-described modes for carrying out the invention which are obvious to those skilled in the art are intended to be within the scope of the following claims. Those skilled in the art will recognize, or be able to ascertain using no more than routine experimentation, many equivalents to the specific embodiments of the invention described herein. Such equivalents are intended to be encompassed by the following claims.

1. An apparatus useful for tail lateral vessel transections of a specimen comprising:
a base;
a first vertical element, wherein the first vertical element comprises a first plurality of holes placed at predetermined positions; and
a second vertical element, wherein the second vertical element is positioned parallel and adjacent to the first vertical element such that a gap is formed between the first and second vertical elements and wherein the second vertical element comprises a second plurality of holes aligned with the first plurality of holes on the first vertical element.

2. The apparatus of claim 1, wherein the specimen is a mammal.

3. The apparatus of claim 2, wherein the mammal is a rodent.

4. The apparatus of claim 2, wherein the rodent is a mouse.

5. The apparatus of claim 1, wherein the base is comprised of a material selected from the group consisting of a plastic, polymer, metal, glass, wood, stone, ceramic, carbon fiber or combination thereof.

6. The apparatus of clam 1, wherein the first and second vertical elements are comprised of a material selected from the group consisting of a plastic, polymer, metal, glass, wood, stone, ceramic, carbon fiber or combination thereof.

7. The apparatus of claim 1, wherein the first and second vertical elements are the same height from the base.

8. The apparatus of claim 1, wherein the gap between the first and second vertical elements is about 0.3 mm to 1.5 mm.

9. The apparatus of clam 1, wherein the first plurality of holes have a diameter of about 2.2 mm to 2.9 mm.

10. The apparatus of claim 1, wherein the first plurality of holes have a diameter of 2.7 mm.

11. The apparatus of claim 1, wherein the second plurality of holes have a diameter of 2.7 mm on an inner face of the second vertical element and a diameter of 8 mm on an outer face of the second vertical element.

12. The apparatus of claim 1, wherein the first plurality of holes and the second plurality of holes have an increasing height from the base.

13. The apparatus of claim 1, further comprising a sliding blade.

14. A method of performing tail vein transections using the apparatus of claim 1 comprising the steps of:
a) providing a specimen,
b) placing the specimen's tail through one aligned pair of holes of the first and second vertical elements,
c) placing a blade in the gap between the vertical elements,
d) resting the handle of blade on top of the vertical elements,
e) running the blade along the vertical elements to make an incision on the tail,
whereby the first and second vertical elements provide a guide for controlling the depth of the incision made on the tail.
